(19) United States
(12) Patent Application Publication
(10) Pub. No.: US 2003/0085848 A1
(43) Pub. Date: May 8, 2003

(54) Method for initialization and stabilization of distortion correction in a head up display unit

(76) Inventor: James Deppe, Naperville, IL (US)

Correspondence Address: BULLWINKEL PARTNERS, LTD., 19 SOUTH LASALLE ST., SUITE 1300, CHICAGO, IL, 60603, US

(21) Appl. No.: 09/683,009

(22) Filed: Nov. 8, 2001

(51) Int. Cl. G09G 5/00

(52) U.S. Cl. 345/7; 345/8

(57) ABSTRACT

The present invention compensates and corrects temperature and distortion errors within a head-up display system using symbol generation and deflection circuitry. The present invention first measures the gain and offset of the symbol generation and deflection circuitry in a controlled environment to create known controlled settings. The circuitry is then installed in an operational head-up display unit where it subsequently dynamically and continuously measures its gain and offset values and consequently adjusts the gain and offset using an adjusting means in order to approximately match the originally derived control settings.

### CROSS REFERENCE TO RELATED APPLICATIONS

This invention is related to my copending patent applications Ser. No. 09/683,005, filed Nov. 8, 2001 and Ser. No. 09/683,006, filed Nov. 8, 2001, all of which are commonly assigned as the present invention, and are incorporated herein by reference.

### BACKGROUND OF INVENTION

The present invention relates generally to the correction of focus and distortional errors inherent with conventional head-up displays. More specifically, the present invention relates to a method to correct focus errors and distortion correction in a head-up display unit attributable to conventional lens trains and cathode ray tube electron beam designs. Yet more specifically, the present invention relates to a method of dynamically adjusting the gain and offset of a cathode ray tube display.

Ever since the early days of vehicle pioneering, there has always been an inherent danger when an operator of a vehicle, such as a pilot of an aircraft or driver of an automobile, must look down from his outward line of site to view important operative status concerning his vehicle. Such status information is normally presented via analog means such as dials, gauges, or gyroscopes, or digital means such as computer readouts, on a readout display, such as an automobile dashboard or pilot's information panel. The operative status may include information such as fuel, speed, direction, orientation, weapons status, and the like.

As such, when the vehicle operator temporarily looks to the vehicle information display to gather this important information, his outward line of sight is momentarily disrupted. This has inherent dangers, especially in fast moving vehicles such as aircraft and the like. Furthermore, once a vehicle operator is finished gathering the pertinent information, which may take a fraction of a second or sometimes minutes, he must then return to his original line of sight and his focus must readjust. These continual visual diversions relates to problems such as tunnel vision and focus impairment.

It should be noted, however, that the disclosure herein will concentrate on aircraft head-up display devices and enhancements. However, the present invention is applicable to not only aircraft, but also any type of vehicle which may incorporate the usage of a head-up display. As such, the description and emphasis of the present invention's usability within an aircraft should not be deemed limiting, but rather an explanation and exemplification of the present invention.

U.S. Pat. No. 3,205,303, to Bradley, issued on Sep. 7, 1965 ('303 patent) attempts to remedy these problems by inventing a remotely controlled remote viewing system. The '303 patent is one of the first so-called “head-up display” (HUD) units which allows a vehicle operator to receive pertinent vehicle information within his outward line of sight. As such, the vehicle operator does not have to continuously look down to the information display panel to view this information.

There have subsequently been many enhancements and improvements to the '303 patent. For example, U.S. Pat. No. 3,291,906 to Ward et al., issued on Dec. 13, 1996, discloses aircraft visual indicating or display systems utilizing a cathode ray tube; U.S. Pat. No. 3,666,887, to Freeman, issued on May 30, 1972, discloses a head-up display; U.S. Pat. No. 4,763,990, to Wood, issued on Aug. 16, 1988, discloses a head-up display system; U.S. Pat. No. 5,007,711, to Wood et al., issued on Apr. 16, 1991, discloses a compact arrangement for head-up display components; U.S. Pat. No. 5,805,119, to Erskine et al., issued on Sep. 8, 1998, discloses a vehicle projected display using a deformable mirror device; and U.S. Pat. No. 5,379,132, to Kuwayama et al., issued on Jan. 3, 1995, discloses a display apparatus for a head-up display system.

The HUD has subsequently become an important component of the instrumentation in high performance aircraft of all types, from tactical fighter aircraft to large commercial transports. By projecting into the pilot's view an accurate and properly aligned real-time representation of the aircraft's orientation and environment, the pilot is enabled to control an aircraft more efficiently and effectively through the transition from visual orientation to instrument orientation and back again, while having at all times an accurate representation, either digital, analog or both, of all major flight instruments and weapons systems controls.

However, inherent with the pertinent information that a HUD displays, a clear, accurate, and precise information projection to the pilot is tantamount. As such, distortion, vibration, and temperature errors must be kept to an absolute minimum in order to make the HUD effective. Visualization errors and distortion cannot be tolerated in these finely tuned assemblies. However, inherent with a HUD's use, constant temperature variations, vibrations, distortion errors, and the like are omnipresent and methods and processes of combating these problems are continuous.

Because of the previously mentioned need for precise and accurate positioning of information in a HUD, it is thus necessary to correct for distortion of the image caused by the cathode ray tube (CRT) electron beam used in conjunction with the lens train. The form of distortion correction must be able to accommodate both conventional, and most widely used in HUD units, stroke-written display generation (where the CRT electron beam moves to each individual display point to be visualized) and raster display generation (where the CRT electron beam performs a progressive left-right sweep from top to bottom, scanning the entire display anew with each pass). However, the conventional wave-shaping techniques generating non-linear horizontal and vertical raster sweep signals cannot be used for stroke-written displays. Analog techniques for solving this problem have been devised, and are in use. The present invention provides significantly better accuracy than these older analog techniques.

Furthermore, there is a direct need within the aircraft industry to allow pieces of these HUD systems to be interchangeable. For example, currently if part of a HUD system fails, it must be replaced and manually realigned on-site. The conventional realignment process is extremely time consuming and very inaccurate. Once a HUD installer believes that the HUD is properly aligned, most distortions and errors subsequently occur during operation of the HUD, such as extreme temperature variations and vibrational loads. As such, it is a back-and-forth process between the pilot and the HUD installer in order to properly perfect the HUD's alignment.

The present invention overcomes the disadvantages and/or shortcomings of known prior HUD alignment and distortion correction methods and apparatus and provides significant improvements thereover.

### SUMMARY OF INVENTION

The present invention corrects field distortion errors due to temperature variations by utilizing a Stroke Raster Graphics Processor (SRGP) card, thus providing an electronic solution enabling individual HUD system components to be swapped between units without losing calibration or requiring independent realignment. A linear transfer function between the screen coordinates (pixels) to CRT electron beam deflection current is created and held constant by an automatic calibrator (Auto Calibrator). By utilizing the Auto Calibrator hardware and software during the manufacturing process, the gain and offset of this transfer function for each individual unit is determined, initialized and maintained, despite any circuit changes induced by changes in the operating aircraft environment.

### BRIEF DESCRIPTION OF DRAWINGS

The preferred embodiment is herein described in detail with references to the drawing, where appropriate, wherein:

FIG. 1 is a block circuit diagram showing the interaction of the electronic components of the HUD of the present invention.

### DETAILED DESCRIPTION

According to the preferred embodiment of the present invention, correction for temperature-induced distortion errors is accomplished in a Stroke Raster Graphics Processor (SRGP) card. A major advantage of the present invention is that individual HUD system components can subsequently be swapped between units without losing calibration and alignment information.

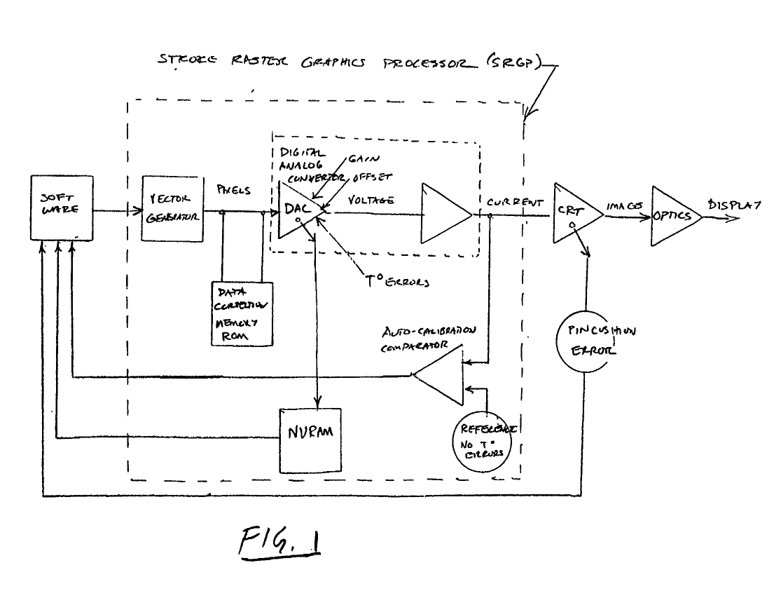

Referring to FIG. 1, the preferred embodiment compensates temperature-induced changes in circuit characteristics by modifying the gain and offset settings controlled by symbol generation and deflection amplifier circuitry and auxiliary digital-to-analog converters. In other words, what is desired is a specific linear transfer function between the screen coordinates (pixels) to CRT electron beam deflection current. The pixel-to-current transfer function is held constant by an automatic calibrator (the Auto Calibrator). The gain and offset of this transfer function is both hardware and software determined to ensure accuracy. By utilizing Auto Calibrator hardware and software during the manufacturing process, the properly aligned gain and offset of this transfer function for each individual unit is determined, initialized, and maintained, despite any circuit changes induced by changes in temperature in the operating aircraft environment. The preferred embodiment of the present invention stores the initially controlled gain and offset data within a storing means.

Specifically, the preferred embodiment enables a vector generator to send digital data information based upon pixel mapping. The data information is passed to a digital analog converter which subsequently converts the digital data information to a conventional analog stream. The vector generator further gathers temperature induced deflection errors from an outside measuring source and subsequently applies appropriate gain and offset manipulations to compensate for such deflection errors to achieve approximately the controlled gain and offset values. The resultant analog information stream is sent to the conventional CRT, which in turn displays the image. This ensures an accurate and continuous CRT output display without any temperature induced errors.

In addition, an alternate embodiment utilizes special phosphor points at predetermined measured locations on the CRT, which, in connection with a correspondingly pre-programmed electron beam, provide accurate and consistent alignment information. These correction points, when associated with a calibration signal impressed on the electron beam, become visible only if the beam moves away from proper calibration. This provides a visible full-time calibration check for the unit. This correction method is not restricted to CRT stroke displays such as used in aircraft head-up displays, but can also be applied to raster displays, including televisions.

The foregoing specification describes only the preferred and alternate embodiments of the invention as shown. Other embodiments besides the above may be articulated as well. The terms and expressions therefore serve only to describe the invention by example only and not to limit the invention. It is expected that others will perceive differences, which while differing from the foregoing, do not depart from the spirit and scope of the invention herein described and claimed.

1. A method of correcting temperature induced symbol generation and deflection errors of a head-up display system, said head-up display system having symbol generation and deflection amplifier circuitry, said method comprising the steps of:
measuring the gain and offset of said symbol generation and deflection circuitry in a controlled environment whereby obtaining a control setting;
installing said symbol generation and deflection circuitry within said head-up display system;
measuring the gain and offset of said symbol generation and deflection circuitry while said symbol generation and deflection circuitry is in an operational state with a measuring means; and
adjusting said gain and offset of said symbol generation and deflection circuitry with an adjusting means to approximately match said control setting while said symbol generation and deflection circuitry is in an operational state.

2. A method as claimed in claim 1 wherein said measuring means is a hardware and software compensating device.

3. A method as claimed in claim 1 wherein said adjusting means consists of altering said gain and offset within a digital to analog converter whereby the output gain and offset is approximately equal to said control settings.
